(19) United States
(12) Patent Application Publication
(10) Pub. No.: US 2024/0036383 A1
(43) Pub. Date: Feb. 1, 2024

(54) DISPLAY PANEL AND DISPLAY DEVICE

(71) Applicant: TCL China Star Optoelectronics Technology Co., Ltd., Shenzhen (CN)

(72) Inventor: Weina YONG, Shenzhen (CN)

(73) Assignee: TCL China Star Optoelectronics Technology Co., Ltd., Shenzhen (CN)

(21) Appl. No.: 17/898,514

(22) Filed: Aug. 30, 2022

(30) Foreign Application Priority Data
Jul. 27, 2022 (CN) 202210889140.3

(51) Int. Cl. G02F 1/1362

(52) U.S. Cl. CPC G02F 1/136209

(57) ABSTRACT

A display panel and a display device are provided. The display panel includes a substrate and a display unit. The display unit includes a pixel region and a light-shielding region. The pixel region includes at least a first sub-pixel, a second sub-pixel, and a third sub-pixel sequentially disposed on the substrate at intervals. The first sub-pixel, the second sub-pixel, and the third sub-pixel are formed of a first color resist material, a second color resist material, and a third color resist material, respectively. The light-shielding region surrounds the first sub-pixel, the second sub-pixel, and the third sub-pixel, and includes a first light-shielding layer and a second light-shielding layer. The first light-shielding layer has a first lower light-shielding region, and the second light-shielding layer has a first upper light-shielding region. The first lower light-shielding region and the first upper light-shielding region are formed of different color resist materials.

### RELATED APPLICATION

This application claims the benefit of priority of Chinese Patent Application No. 202210889140.3 filed on Jul. 27, 2022, the contents of which are incorporated herein by reference in their entirety.

### TECHNICAL FIELD

The present application relates to a technical field of display technology, and particularly relates to a display panel and a display device.

### BACKGROUND

In a conventional thin film transistor liquid crystal display (TFT-LCD), four masks are generally used respectively in processes for BM (black matrix)/R/G/B. The BM functions for shielding lights. The processes for R/G/B use color masks to realize a function of filtering the lights. A color of a color resist material of the BM is different from a color of R/G/B. That is, different masks are required for preparing BM/R/G/B. Therefore, four masks and four processes are needed to complete processes for BM/R/G/B, causing a complexity overall.

### SUMMARY

An embodiment of the present application provides a display panel and a display device, wherein color resist material of sub-pixels in the pixel region are directly combined to prepare the light-shielding region, and no additional color resist materials of different colors and additional preparation process are required to prepare the light-shielding region, thereby reducing the product cost and improving preparation efficiency.

In a first aspect, an embodiment of the present application provides a display panel including a substrate and a display unit disposed on the substrate in an array, wherein the display unit includes:
a pixel region at least including a first sub-pixel, a second sub-pixel, and a third sub-pixel sequentially disposed on the substrate at intervals, wherein the first sub-pixel is formed of a first color resist material, the second sub-pixel is formed of a second color resist material, and the third sub-pixel is formed of a third color resist material; and
a light-shielding region surrounding the first sub-pixel, the second sub-pixel, and the third sub-pixel in the pixel region, wherein the light-shielding region includes a first light-shielding layer and a second light-shielding layer sequentially stacked, the first light-shielding layer includes a first lower light-shielding region formed of the first color resist material or the second color resist material or the third color resist material, the second light-shielding layer includes a first upper light-shielding region formed of the first color resist material or the second color resist material or the third color resist material, and the first lower light-shielding region and the first upper light-shielding region are formed of different color resist materials.

In some embodiments, a number of light-shielding layers included in the light-shielding region is less than or equal to a number of sub-pixels included in the pixel region.

In some embodiments, the first light-shielding layer includes the first lower light-shielding region formed of the first color resist material and a second lower light-shielding region formed of the second color resist material, and the second light-shielding layer is formed of the third color resist material.

In some embodiments, the second light-shielding layer includes the first upper light-shielding region formed of the first color resist material and a second upper light-shielding region formed of the second color resist material, and the first light-shielding layer is formed of the third color resist material.

In some embodiments, the first light-shielding layer includes the first lower light-shielding region formed of the first color resist material and a second lower light-shielding region formed of the second color resist material, the second light-shielding layer includes the first upper light-shielding region formed of the second color resist material and a second upper light-shielding region formed of the third color resist material, wherein in a direction along which the first light-shielding layer and the second light-shielding layer stacked, the upper light-shielding region and the lower light-shielding region formed of a same color resist material are staggered from each other.

In some embodiments, the first light-shielding layer includes the first lower light-shielding region formed of the first color resist material and a second lower light-shielding region formed of the second color resist material, the second light-shielding layer includes the first upper light-shielding region formed of the first color resist material, a second upper light-shielding region formed of the second color resist material, and a third upper light-shielding region formed of the third color resist material, wherein in a direction along which the first light-shielding layer and the second light-shielding layer stacked, the upper light-shielding region and the lower light-shielding region formed of a same color resist material are staggered from each other.

In some embodiments, the first light-shielding layer includes the first lower light-shielding region formed of the first color resist material, a second lower light-shielding region formed of the second color resist material, and a third lower light-shielding region formed of the third color resist material, the second light-shielding layer includes the first upper light-shielding region formed of the first color resist material and a second upper light-shielding region formed of a second color resist material, wherein in a direction along which the first light-shielding layer and the second light-shielding layer stacked, the upper light-shielding region and the lower light-shielding region formed of a same color resist material are staggered from each other.

In some embodiments, the first light-shielding layer includes the first lower light-shielding region formed of the first color resist material, a second lower light-shielding region formed of the second color resist material, and a third lower light-shielding region formed of the third color resist material, the second light-shielding layer includes the first upper light-shielding region formed of the first color resist material, a second upper light-shielding region formed of the second color resist material, and a third upper light-shielding region formed of the third color resist material, wherein in a direction along which the first light-shielding layer and the second light-shielding layer stacked, the upper light-shielding region and the lower light-shielding region formed of a same color resist material are staggered from each other.

In some embodiments, the light-shielding region further includes a third light-shielding layer stacked on the second light-shielding layer, the first light-shielding layer is formed of the first color resist material, the second light-shielding layer is formed of the second color resist material, and the third light-shielding layer is formed of the third color resist material.

In a second aspect, the present application provides a display device including the display panel according to any one of the above.

According to the display panel and display device provided, since the lights are blocked from transmitting due to a stack of at least two color resists, two or more color resist materials are directly selected from the existing sub-pixels in the pixel region of the display panel to form a light-shielding region of the display panel, and no additional color resist materials of different colors are needed for the light-shielding region, thereby reducing the product cost.

### BRIEF DESCRIPTION OF THE DRAWINGS

The technical solution and other advantageous effects of the present application will be apparent from the following detailed description of specific embodiments of the present application with reference to the accompanying drawings.

FIG. 1 is a schematic structural diagram of a display panel according to an embodiment of the present application.

FIG. 2 is a schematic cross-sectional diagram of a display panel according to an embodiment of the present application.

FIG. 3 is a schematic cross-sectional diagram of a display panel according to an embodiment of the present application.

FIG. 4 is a schematic cross-sectional diagram of a display panel according to an embodiment of the present application.

FIG. 5 is a schematic cross-sectional diagram of a display panel according to an embodiment of the present application.

FIG. 6 is a schematic cross-sectional diagram of a display panel according to an embodiment of the present application.

FIG. 7 is a schematic cross-sectional diagram of a display panel according to an embodiment of the present application.

FIG. 8 is a schematic cross-sectional diagram of a display panel according to an embodiment of the present application.

FIG. 9 is a schematic cross-sectional diagram of a display panel according to an embodiment of the present application.

FIG. 10 is a schematic diagram of a preparation flow of a display panel according to an embodiment of the present application.

### REFERENCE NUMERALS

1. pixel region; 11. first sub-pixel; 12. second sub-pixel; 13. third sub-pixel; 2. light-shielding region; 21. first light-shielding layer; 211. first lower light-shielding region; 212. second lower light-shielding region; 213. third lower light-shielding region; 22. second light-shielding layer; 221. first upper light-shielding region; 222. second upper light-shielding region; 223. third upper light-shielding region; 23. third light-shielding layer.

### DETAILED DESCRIPTION OF THE EMBODIMENTS

The technical solution in the embodiment of the present application will be described clearly and completely below with reference to the drawings in the embodiment of the present application. Obviously, the described embodiments are only a part of the embodiments of the present application, not all embodiments. Based on the embodiments in the present application, all other embodiments obtained by a person skilled in the art without involving any inventive effort fall within the scope of the present application.

In the description of the present application, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counter-clockwise” and the like, indicate azimuth or positional relationships based on the drawings, merely for ease of description and simplicity, and do not indicate or imply that the device or element referred to must have a particular azimuth, be constructed and operated in a particular azimuth, and are therefore not to be construed as limiting the present application. Furthermore, the terms “first” and “second” are used for descriptive purposes only and are not to be construed as indicating or implying relative importance or implying the number of features. Thus, a feature defining with “first”, “second” may explicitly or implicitly include one or more of the recited features. In the description of this application, the meaning of “a plurality” is two or more unless specifically defined otherwise.

In the description of the present application, it should be noted that the terms “mount”, “link” and “connect” are in a broad sense unless explicitly stated and defined otherwise, and may be, for example, a fixed connection, a detachable connection, or an integral connection; may be a mechanical connection, an electrical connection, or a communication; may be a directly connection or a indirectly connection through an intermediate medium; and may be a communication between the two elements or an interaction relationship of two elements. The specific meaning of the above terms in this application should be understood by one of ordinary skill in the art depending on the particular circumstances.

In this application, unless explicitly stated or defined otherwise, a definition where a first feature is “above” or “below” a second feature may include a definition where the first feature and the second feature are in a directly contact, and a definition where the first feature and the second feature are in an indirectly contact through an additional feature therebetween. A definition where a first feature is “above”, “over”, “on” a second feature may include a definition where the first feature is directly above and obliquely above the second feature, or merely indicates the first feature at a higher level than the second feature. A definition where a first feature is “below”, “under”, “down” a second feature may include a definition where the first feature is directly below and obliquely below the second feature, or merely indicates the first feature at a lower level than the second feature.

The following disclosure provides many different embodiments or examples for implementing the various structures of the present application. To simplify the disclosure of this application, components and arrangements of specific examples are described below. They are merely exemplified and are not intended to limit the present application. Furthermore, the present application may repeat reference numerals and/or reference letters in different examples, such repetition being for simplicity and clarity purposes and not indicating the relationship between the various embodiments and/or arrangements. In addition, the present application provides examples of various specific processes and materials, but one of ordinary skill in the art may recognize the use of other processes and/or materials.

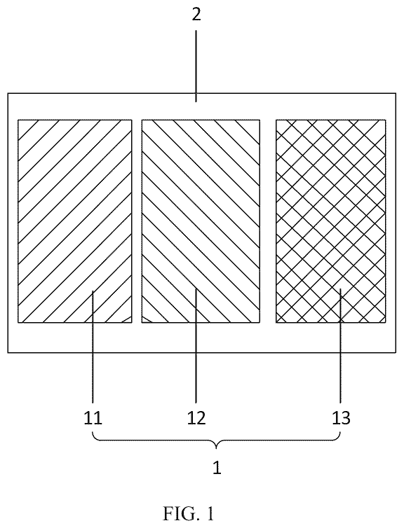

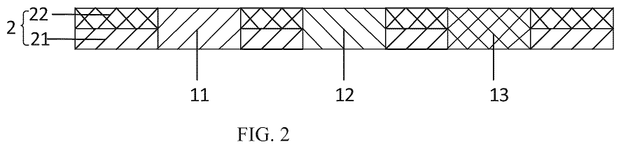

Referring to FIGS. 1 and 2, a display panel is provided in an embodiment of the present application. The display panel sequentially includes a substrate and a plurality of display units, and the display units are disposed on the substrate in an array. Here, the substrate is coated with photoresist materials of different colors to obtain the respective display units. The parameters, such as the material of the substrate, are set based on the requirements of the display panel, and this embodiment is not specifically limited.

The display unit includes a pixel region and a light-shielding region 2, wherein the pixel region includes at least three sub-pixels of a first sub-pixel 11, a second sub-pixel 12 and a third sub-pixel 13. The first sub-pixel 11, the second sub-pixel 12 and the third sub-pixel 13 are all disposed on the substrate. The first sub-pixel 11, the second sub-pixel 12 and the third sub-pixel 13 are sequentially disposed at intervals, and the intervals thereof are set according to the requirements of the display panel. For example, each sub-pixel in the pixel region is evenly disposed at intervals to balance the display effect. Meanwhile, the preparation processes of different sub-pixels are the same.

The first sub-pixel 11 is formed of a first color resist material, the second sub-pixel 12 is formed of a second color resist material, and the third sub-pixel 13 is formed of a third color resist material. The first sub-pixel 11, the second sub-pixel 12, and the third sub-pixel 13 correspond to sub-pixels of different colors, respectively. For example, the first sub-pixel 11, the second sub-pixel 12, and the third sub-pixel 13 correspond to a red sub-pixel, a green sub-pixel, and a blue sub-pixel, respectively. The first sub-pixel 11, the second sub-pixel 12, and the third sub-pixel 13 are respectively lightened for display. In addition, the pixel region may include sub-pixels of more kinds of colors depending on the display requirement. For example, the pixel region may also include a fourth sub-pixel and the like, and the colors of the sub-pixels are not limited.

The light-shielding region 2 shields signal traces and the like to realize a light-shielding function. The first sub-pixel 11, the second sub-pixel 12, and the third sub-pixel 13 in the pixel region are sequentially at intervals. The light-shielding region 2 surrounds the first sub-pixel 11, the second sub-pixel 12, and the third sub-pixel 13 in the pixel region. That is, the light-shielding region 2 is disposed among the first sub-pixel 11, the second sub-pixel 12, and the third sub-pixel 13 in the pixel region, and is disposed surrounding the first sub-pixel 11, the second sub-pixel 12, and the third sub-pixel 13.

The lights are blocked from transmitting due to a stack of any two color resists, which functions equivalently to a black matrix BM. Therefore, at least two color resists are stacked in the light-shielding region 2 to realize the light-shielding function. Therefore, the light-shielding region 2 includes a first light-shielding layer 21 and a second light-shielding layer 22 which are sequentially stacked, wherein the first light-shielding layer 21 and the second light-shielding layer 22 are formed of different color resist materials to realize a light-shielding function.

The first light-shielding layer 21 includes a first lower light-shielding region formed of a first color resist material or a second color resist material or a third color resist material. The second light-shielding layer 22 includes a first upper light-shielding region formed of a first color resist material or a second color resist material or a third color resist material. The first lower light-shielding region and the first upper light-shielding region are formed of different color resist materials. That is, the light-shielding region 2 functions to shield the lights by two light-shielding layers, and each of the two light-shielding layers includes a color resist of one color.

In this embodiment, the color resist material forming the first light-shielding layer 21 and the second light-shielding layer 22 is the same as the color resist material forming the sub-pixel in the pixel region, as such, the color resist material of the same color can be prepared by a same process. Since there is no need to provide an additional color resist material of other different colors for the light-shielding region 2, the preparation process is reduced, and the product cost is reduced.

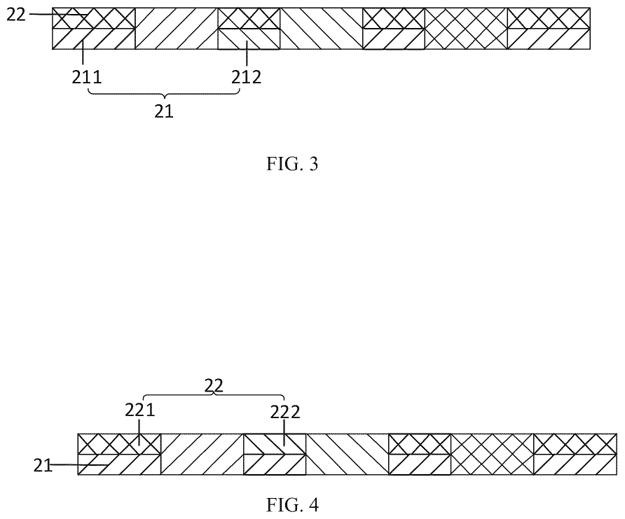

In an embodiment, as shown in FIG. 3, the light-shielding region 2 functions to shield the lights by two light-shielding layers. The lower light-shielding layer, i.e., the first light-shielding layer 21, includes color resists of two different colors. The upper light-shielding layer, i.e., the second light-shielding layer 22, includes a color resist of one color. That is, the first light-shielding layer 21 includes a first lower light-shielding region 211 formed of a first color resist material and a second lower light-shielding region 212 formed of a second color resist material. Since color resists of different colors are required to be stacked in the light-shielding region, the second light-shielding layer 22 is formed of a third color resist material.

In an embodiment, as shown in FIG. 4, the light-shielding region 2 functions to shield the lights by two light-shielding layers. The lower light-shielding layer, i.e., the first light-shielding layer 21, includes a color resists of one color. The upper light-shielding layer, i.e., the second light-shielding layer 22, includes color resists of different two colors. That is, the second light-shielding layer 22 includes a first upper light-shielding region 221 formed of a first color resist material and a second upper light-shielding region 222 formed of a second color resist material. Since color resists of different colors are required to be stacked in the light-shielding region, the first light-shielding layer 21 is formed of a third color resist material.

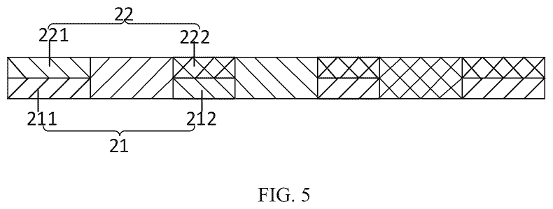

In an embodiment, as shown in FIG. 5, the light-shielding region 2 functions to shield the lights by two light-shielding layers. The lower light-shielding layer, i.e., the first light-shielding layer 21, includes color resists of two different colors. The upper light-shielding layer, i.e., the second light-shielding layer 22, includes color resist of two different colors. The first light-shielding layer 21 includes a first lower light-shielding region 211 formed of a first color resist material and a second lower light-shielding region 212 formed of a second color resist material. The second light-shielding layer 22 includes a first upper light-shielding region 221 formed of a second color resist material and a second upper light-shielding region 222 formed of a third color resist material. In a stacking direction of the first light-shielding layer 21 and the second light-shielding layer 22, the upper light-shielding region and the lower light-shielding region formed of a same color resist material are staggered from each other. That is, the upper light-shielding region and the lower light-shielding region on a same stacking position are formed of different color resist materials. The upper light-shielding region includes a first upper light-shielding region 221, a second upper light-shielding region 222, and a third upper light-shielding region 223. The lower light-shielding region includes a first lower light-shielding region 211, a second lower light-shielding region 212, and a third lower light-shielding region 213.

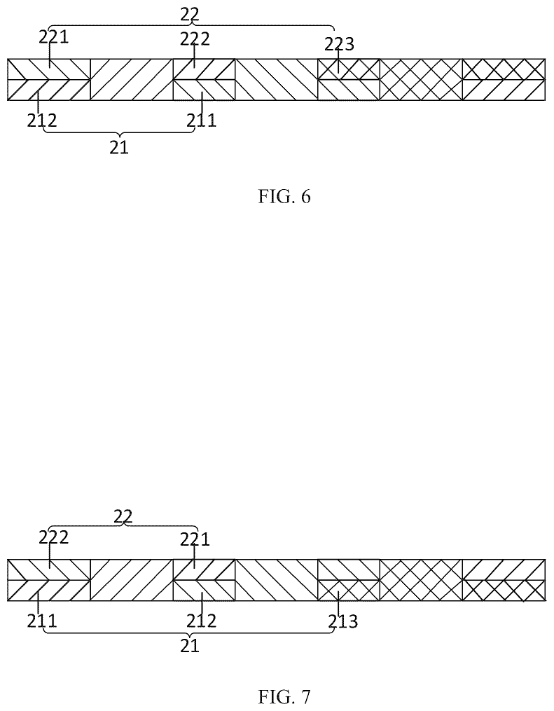

In an embodiment, as shown in FIG. 6, the light-shielding region 2 functions to shield the lights by two light-shielding layers. The lower light-shielding layer, i.e., the first light-shielding layer 21, includes color resists of two different colors. The upper light-shielding layer, i.e., the second light-shielding layer 22, includes color resist of three different colors. The first light-shielding layer 21 includes a first lower light-shielding region 211 formed of a first color resist material and a second lower light-shielding region 212 formed of a second color resist material. The second light-shielding layer 22 includes a first upper light-shielding region 221 formed of a first color resist material, a second upper light-shielding region 222 formed of a second color resist material, and a third upper light-shielding region 223 formed of a third color resist material. In a stacking direction of the first light-shielding layer 21 and the second light-shielding layer 22, the upper light-shielding region and the lower light-shielding region formed of a same color resist material are staggered from each other. That is, the upper light-shielding region and the lower light-shielding region on a same stacking position are formed of different color resist materials.

In an embodiment, as shown in FIG. 7, the light-shielding region 2 functions to shield the lights by two light-shielding layers. The lower light-shielding layer, i.e., the first light-shielding layer 21, includes color resists of three different colors, and the upper light-shielding layer, i.e., the second light-shielding layer 22, includes color resists of two different colors. The first light-shielding layer 21 includes a first lower light-shielding region 211 formed of a first color resist material, a second lower light-shielding region 212 formed of a second color resist material, and a third lower light-shielding region 213 formed of a third color resist material. The second light-shielding layer 22 includes a first upper light-shielding region 221 formed of a first color resist material and a second upper light-shielding region 222 formed of a second color resist material. In a stacking direction of the first light-shielding layer 21 and the second light-shielding layer 22, the upper light-shielding region and the lower light-shielding region formed of a same color resist material are staggered from each other. That is, the upper light-shielding region and the lower light-shielding region on a same stacking position are formed of different color resist materials.

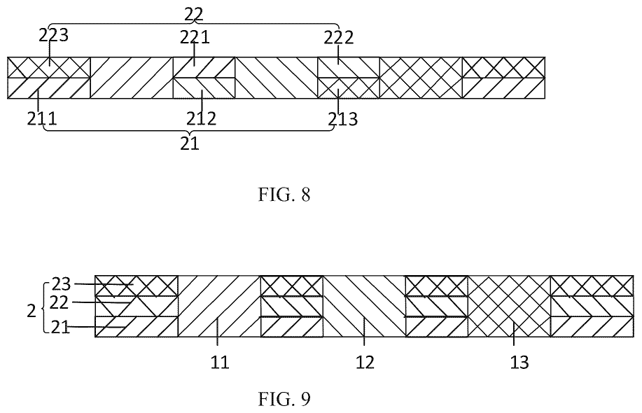

In an embodiment, as shown in FIG. 8, the light-shielding region 2 functions to shield the lights by two light-shielding layers. The lower light-shielding layer, i.e., the first light-shielding layer 21, includes color resists of three different colors. The upper light-shielding layer, i.e., the second light-shielding layer 22, includes color resists of three different colors. The first light-shielding layer 21 includes a first lower light-shielding region 211 formed of a first color resist material, a second lower light-shielding region 212 formed of a second color resist material, and a third lower light-shielding region 213 formed of a third color resist material. The second light-shielding layer 22 includes a first upper light-shielding region 221 formed of a first color resist material, a second upper light-shielding region 222 formed of a second color resist material, and a third upper light-shielding region 223 formed of a third color resist material. In a stacking direction of the first light-shielding layer 21 and the second light-shielding layer 22, the upper light-shielding region and the lower light-shielding region formed of a same color resist material are staggered from each other, that is, the upper light-shielding region and the lower light-shielding region on a same stacking position are formed of different color resist materials.

In an embodiment, as shown in FIG. 9, the light-shielding region 2 functions to shield the lights by three light-shielding layers. The first light-shielding layer 21, the second light-shielding layer 22, and the third light-shielding layer 23 are sequentially stacked. Each of the light-shielding layers includes a color resist of one color. The first light-shielding layer 21 is formed of a first color resist material, the second light-shielding layer 22 is formed of a second color resist material, and the third light-shielding layer 23 is formed of a third color resist material.

It should be noted that the size and position of the different light-shielding regions can be flexibly set for the light-shielding layer having at least two light-shielding regions in the above-described embodiment without affecting the light-shielding effect.

In an embodiment, all light-shielding regions of the light-shielding region 2 are formed of a same color resist material as the pixel regions, as such, the number of light-shielding layers included in the light-shielding regions 2 is less than or equal to the number of sub-pixels included in the pixel regions. The number of the light-shielding layers and the color resist materials of different colors can be flexibly set as required, and this embodiment is not specifically limited.

However, in order to save processing steps, the color resists of the same color in the pixel region and in the light-shielding region 2 can be prepared by the same process That is, if the light-shielding layer formed of the first color resist material is provided in the light-shielding region 2, the first sub-pixel 11 of the pixel region and the light-shielding layer formed of the first color resist material in the light-shielding region 2 are prepared simultaneously, and it is not necessary to add an additional step to prepare the light-shielding region 2, thereby improving the production efficiency.

Since the light-shielding layers in the light-shielding region 2 are stacked, it is apparent that the lower light-shielding layer in the light-shielding region 2 needs to be prepared before the upper light-shielding layer. The color resist corresponding to the lower light-shielding layer needs to be prepared before the color resist corresponding to the upper light-shielding layer. Therefore, the stacking order of the color resists of different colors in the light-shielding region 2 determines the preparation order of the sub-pixels corresponding to the different colors in the pixel region.

If the light blocking region 2 does not includes a color resist of a certain color, the preparation order of sub-pixels corresponding to the certain color is not required. For example, the light-shielding region 2 functions to shield the lights by two light-shielding layers, wherein the first light-shielding layer 21 is formed of a first color resist material, and the second light-shielding layer 22 is formed of a second color resist material. Based on the stacking order of the light-shielding region 2, the first sub-pixel 11 in the pixel region is prepared before the second sub-pixel 12, but the third sub-pixel 13 may be prepared at any time.

It should be noted that the above-described embodiments describe various arrangements of the light-shielding area 2 correspondingly to which the pixel region includes sub-pixels of three colors. However, in practice, the pixel region may include sub-pixels of more colors, more light-shielding layers may be correspondingly provided in the light-shielding region 2, and each light-shielding layer may have more selection on color resist material of more colors.

In an embodiment, in order to ensure flatness of the display panel overall, a thickness of the pixel region is the same as a thickness of the light-shielding region 2, wherein a direction along the thickness is a direction stacking the first light-shielding layer 21 and the second light-shielding layer 22. Therefore, the thickness of each sub-pixel of the pixel region is the same, that is, a thickness of the first sub-pixel 11, a thickness of the second sub-pixel 12, and a thickness of the third sub-pixel 13 of the pixel region are the same.

In an embodiment, since at least two light-shielding layers are stacked on each portion of the light-shielding region 2, the thickness of the sub-pixel in the pixel region is greater than the thickness of each light-shielding layer in the light-shielding region 2. However, the sum of the thickness of all the stacked light-shielding layers in the light-shielding region 2 is the same as the thickness of each sub-pixel in the pixel region.

Since the light-shielding region 2 and the pixel region are formed by a color resist of a same color, they can be produced by the same process. The light-shielding region 2 and the pixel region formed by the color resist of the same color have different thickness, thus, the light-shielding region 2 and the pixel region can be produced by using a half tone mask (HTM) with the half transmittance. Since negative photoresist material is used on sides of the color filter (CF), the residual thickness of the color resist is thicker in the part with more illumination, and is thinner in the part with less illumination, different thickness can be obtained according to the transmittance of different regions of the HTM. For example, the light-shielding region 2 functions to shield the lights by two light-shielding layers. The first light-shielding layer 21 includes a first lower light-shielding region 211 formed of a first color resist material and a second lower light-shielding region 212 formed of a second color resist material. The second light-shielding layer 22 is formed of a third color resist material. The thickness of the two light-shielding layers in the light-shielding region are the same, that is, the thickness of the first light-shielding layer 21 in the light-shielding region 2 and the thickness of the second light-shielding layer 22 in the light-shielding region 2 are half of the thickness of the first sub-pixel 11 in the pixel region. When the first sub-pixel 11 is prepared, a transmittance of a portion of a used mask corresponding to the first sub-pixel in the pixel region is 100%, a transmittance of a portion of the used mask corresponding to the first lower light-shielding layer in the first light-shielding layer 21 in the light-shielding region 2 is 50%, and a transmittance of a portion of the used mask corresponding to the second lower light-shielding layer in the first light-shielding layer 21 in the light-shielding region 2 and corresponding to the pixel region is 0%. The mask corresponding to the second sub-pixel 12 and the third sub-pixel 13 is determined based on the above way, and the second sub-pixel 12 and the third sub-pixel 13 are prepared through the mask.

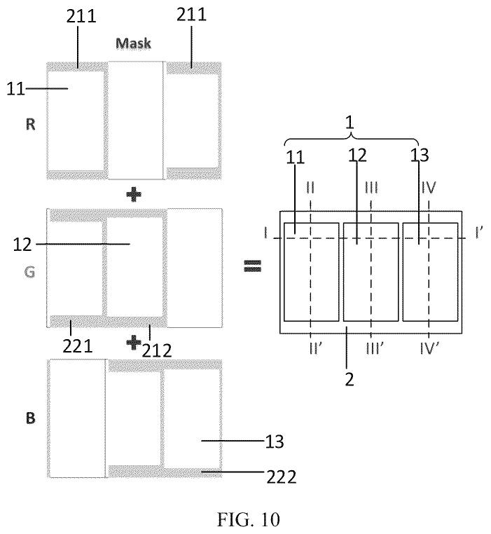

As shown in FIG. 10, the light-shielding region 2 functions to shield the lights by two light-shielding layers, i.e., a first light-shielding layer 21 and a second light-shielding layer 22. The first sub-pixel 11 is formed of a red color resist, the second sub-pixel 12 is formed of a green color resist, and the third sub-pixel 13 is formed of a blue color resist. The first light-shielding layer 21 includes a first lower light-shielding region 211 formed of a red color resist and a second lower light-shielding region 212 formed of a green color resist. The second light-shielding layer 22 includes a first upper light-shielding region 221 formed of a green color resist and a second upper light-shielding region 222 formed of a blue color resist. As shown in FIG. 10, a transmittance of a portion of a first mask corresponding to the first sub-pixel 11 in the pixel region 1 is 100%, a transmittance of a portion of the first mask corresponding to the first lower light-shielding layer 211 in the first light-shielding layer 21 in the light-shielding region 2 is 50%, and a transmittance of a portion of the first mask corresponding to the other regions is 0%, wherein the first mask corresponds to the red color resist. A transmittance of a portion of a second mask corresponding to the second sub-pixel 12 in the pixel region 1 is 100%, a transmittance of a portion of the second mask corresponding to the second lower light-shielding layer 212 in the first light-shielding layer 21 in the light-shielding region 2 and to the first upper light-shielding region 221 in the second light-shielding layer 22 is 50%, and a transmittance of a portion of the second mask corresponding to the other regions is 0%, wherein the second mask corresponds to the green color resist. A transmittance of a portion of a third mask corresponding to the third sub-pixel 13 in the pixel region 1 is 100%, a transmittance of a portion of the second mask corresponding to the second upper light-shielding layer 222 in the second light-shielding layer 22 in the light-shielding region 2 is 50%, and a transmittance of a portion of the third mask corresponding to the other regions is 0%, wherein the third mask corresponds to the blue color resist. As shown in FIG. 10, a display panel is prepared by using the first mask, the second mask, and the third mask sequentially, according to the stacking order of the resists in the light-shielding region 2.

In the actual production process, the first sub-pixel 11 may correspond to a red color resist, the second sub-pixel 12 may correspond to a green color resist, and the third sub-pixel 13 may correspond to a blue color resist. As such, thickness of overlap regions among the red pixel, the green pixel and the blue pixel, as well as an actual size of an ox horn-shaped region can be adjusted by adjusting the light transmittance of the semi-transparent region, wherein the ox horn-shaped region is formed in the light-shielding region 2 by overlapping two of the red color resist, the green color resist and the blue color resist. For example, the thickness of the overlap regions can be thicker and the area of the overlap regions can be larger with the transmittance of the semi-transparent region increasing from 50%, in this way the ox horn-shaped region can be greater. The thickness of the overlap regions can be thinner and the area of the overlap regions can be smaller with the transmittance of the semi-transparent region decreasing from 50%, in this way the ox horn-shaped region can be smaller. The thickness and area of the overlap region, as well as the size of the ox horn-shaped region affect a performance of the panel on large viewing angle. Thus, the viewing angle can be optimized and improved by adjusting the transmittance of the semi-transparent region according to an actual large viewing angle optical performance of the panel.

It should be noted that different color resist materials have different degrees on absorbing the lights, and a transmittance with 50% is not an optimum value of the semi-transparent region. As such, the transmittance of the different color resist materials in the semi-transparent region should be adjusted by actual production tests to obtain an optimum condition of the ox horn shaped region and a large viewing angle performance.

In this embodiment, the color resist material of sub-pixels in the pixel region are directly combined to prepare the light-shielding region 2, and at the same time, the light-shielding region 2 and the sub-pixels having a same color with the light-shielding region 2 in the pixel region are prepared by a same process using a same mask. Thus, no additional color resist materials of different colors and additional preparation process are required to prepare the light-shielding region 2, thereby reducing the product cost and improving preparation efficiency.

An embodiment of the present application provides a display device including the display panel according to any one of the embodiments described above.

In the above embodiments, the description of each embodiment is focused on, and a certain embodiment may be not described in detail and the references may be made to relevant description of other embodiments.

The technical features of the above embodiments can be combined arbitrarily. In order to make the description concise, not all the possible combinations of the technical features in the above embodiments are described. However, as long as the combination of the technical features is not inconsistent, it should be considered as the scope of the present specification.

The detailed description of a display panel and a display device is provided above by embodiments of the present application. The principles and embodiments of the present invention are described herein using specific examples. The description of the above embodiments is only for helping to understand the method and the core idea of the present invention. Meanwhile, to those skilled in the art, according to the idea of the present invention, there may be variations in both the detailed embodiments and the scope of application, and the present description should not be construed as limiting the present invention.

What is claimed is:

1. A display panel, comprising a substrate and a display unit disposed on the substrate in an array, wherein the display unit comprises:
sub-pixel sequentially disposed on the substrate at intervals, wherein the first sub-pixel is formed of a first color resist material, the second sub-pixel is formed of a second color resist material, and the third sub-pixel is formed of a third color resist material; and
a light-shielding region surrounding the first sub-pixel, the second sub-pixel, and the third sub-pixel in the pixel region, wherein the light-shielding region comprises a first light-shielding layer and a second light-shielding layer sequentially stacked, the first light-shielding layer comprises a first lower light-shielding region formed of the first color resist material or the second color resist material or the third color resist material, the second light-shielding layer comprises a first upper light-shielding region formed of the first color resist material or the second color resist material or the third color resist material, and the first lower light-shielding region and the first upper light-shielding region are formed of different color resist materials.

2. The display panel of claim 1, wherein a number of light-shielding layers included in the light-shielding region is less than or equal to a number of sub-pixels included in the pixel region.

3. The display panel of claim 1, wherein the first light-shielding layer comprises the first lower light-shielding region formed of the first color resist material and a second lower light-shielding region formed of the second color resist material, and the second light-shielding layer is formed of the third color resist material.

4. The display panel of claim 1, wherein the second light-shielding layer comprises the first upper light-shielding region formed of the first color resist material and a second upper light-shielding region formed of the second color resist material, and the first light-shielding layer is formed of the third color resist material.

5. The display panel of claim 1, wherein the first light-shielding layer comprises the first lower light-shielding region formed of the first color resist material and a second lower light-shielding region formed of the second color resist material, the second light-shielding layer comprises the first upper light-shielding region formed of the second color resist material and a second upper light-shielding region formed of the third color resist material, wherein in a direction along which the first light-shielding layer and the second light-shielding layer stacked, the upper light-shielding region and the lower light-shielding region formed of a same color resist material are staggered from each other.

6. The display panel of claim 1, wherein the first light-shielding layer comprises the first lower light-shielding region formed of the first color resist material and a second lower light-shielding region formed of the second color resist material, the second light-shielding layer comprises the first upper light-shielding region formed of the first color resist material, a second upper light-shielding region formed of the second color resist material, and a third upper light-shielding region formed of the third color resist material, wherein in a direction along which the first light-shielding layer and the second light-shielding layer stacked, the upper light-shielding region and the lower light-shielding region formed of a same color resist material are staggered from each other.

7. The display panel of claim 1, wherein the first light-shielding layer comprises the first lower light-shielding region formed of the first color resist material, a second lower light-shielding region formed of the second color resist material, and a third lower light-shielding region formed of the third color resist material, the second light-shielding layer comprises the first upper light-shielding region formed of the first color resist material and a second upper light-shielding region formed of a second color resist material, wherein in a direction along which the first light-shielding layer and the second light-shielding layer stacked, the upper light-shielding region and the lower light-shielding region formed of a same color resist material are staggered from each other.

8. The display panel of claim 1, wherein the first light-shielding layer comprises the first lower light-shielding region formed of the first color resist material, a second lower light-shielding region formed of the second color resist material, and a third lower light-shielding region formed of the third color resist material, the second light-shielding layer comprises the first upper light-shielding region formed of the first color resist material, a second upper light-shielding region formed of the second color resist material, and a third upper light-shielding region formed of the third color resist material, wherein in a direction along which the first light-shielding layer and the second light-shielding layer stacked, the upper light-shielding region and the lower light-shielding region formed of a same color resist material are staggered from each other.

9. The display panel of claim 1, wherein the light-shielding region further comprises a third light-shielding layer stacked on the second light-shielding layer, the first light-shielding layer is formed of the first color resist material, the second light-shielding layer is formed of the second color resist material, and the third light-shielding layer is formed of the third color resist material.

10. A display device, comprising a display panel, wherein the display panel comprises a substrate and a display unit disposed on the substrate in an array, wherein the display unit comprises: a pixel region at least comprising a first sub-pixel, a second sub-pixel, and a third sub-pixel sequentially disposed on the substrate at intervals, wherein the first sub-pixel is formed of a first color resist material, the second sub-pixel is formed of a second color resist material, and the third sub-pixel is formed of a third color resist material; and
a light-shielding region surrounding the first sub-pixel, the second sub-pixel, and the third sub-pixel in the pixel region, wherein the light-shielding region comprises a first light-shielding layer and a second light-shielding layer sequentially stacked, the first light-shielding layer comprises a first lower light-shielding region formed of the first color resist material or the second color resist material or the third color resist material, the second light-shielding layer comprises a first upper light-shielding region formed of the first color resist material or the second color resist material or the third color resist material, and the first lower light-shielding region and the first upper light-shielding region are formed of different color resist materials.

11. The display device of claim 10, wherein a number of light-shielding layers included in the light-shielding region is less than or equal to a number of sub-pixels included in the pixel region.

12. The display device of claim 10, wherein the first light-shielding layer comprises the first lower light-shielding region formed of the first color resist material and a second lower light-shielding region formed of the second color resist material, and the second light-shielding layer is formed of the third color resist material.

13. The display device of claim 10, wherein the second light-shielding layer comprises the first upper light-shielding region formed of the first color resist material and a second upper light-shielding region formed of the second color resist material, and the first light-shielding layer is formed of the third color resist material.

14. The display device of claim 10, wherein the first light-shielding layer comprises the first lower light-shielding region formed of the first color resist material and a second lower light-shielding region formed of the second color resist material, the second light-shielding layer comprises the first upper light-shielding region formed of the second color resist material and a second upper light-shielding region formed of the third color resist material, wherein in a direction along which the first light-shielding layer and the second light-shielding layer stacked, the upper light-shielding region and the lower light-shielding region formed of a same color resist material are staggered from each other.

15. The display device of claim 10, wherein the first light-shielding layer comprises the first lower light-shielding region formed of the first color resist material and a second lower light-shielding region formed of the second color resist material, the second light-shielding layer comprises the first upper light-shielding region formed of the first color resist material, a second upper light-shielding region formed of the second color resist material, and a third upper light-shielding region formed of the third color resist material, wherein in a direction along which the first light-shielding layer and the second light-shielding layer stacked, the upper light-shielding region and the lower light-shielding region formed of a same color resist material are staggered from each other.

16. The display device of claim 10, wherein the first light-shielding layer comprises the first lower light-shielding region formed of the first color resist material, a second lower light-shielding region formed of the second color resist material, and a third lower light-shielding region formed of the third color resist material, the second light-shielding layer comprises the first upper light-shielding region formed of the first color resist material and a second upper light-shielding region formed of a second color resist material, wherein in a direction along which the first light-shielding layer and the second light-shielding layer stacked, the upper light-shielding region and the lower light-shielding region formed of a same color resist material are staggered from each other.

17. The display device of claim 10, wherein the first light-shielding layer comprises the first lower light-shielding region formed of the first color resist material, a second lower light-shielding region formed of the second color resist material, and a third lower light-shielding region formed of the third color resist material, the second light-shielding layer comprises the first upper light-shielding region formed of the first color resist material, a second upper light-shielding region formed of the second color resist material, and a third upper light-shielding region formed of the third color resist material, wherein in a direction along which the first light-shielding layer and the second light-shielding layer stacked, the upper light-shielding region and the lower light-shielding region formed of a same color resist material are staggered from each other.

18. The display device of claim 10, wherein the light-shielding region further comprises a third light-shielding layer stacked on the second light-shielding layer, the first light-shielding layer is formed of the first color resist material, the second light-shielding layer is formed of the second color resist material, and the third light-shielding layer is formed of the third color resist material.
